(19) United States
(12) Patent Application Publication
(10) Pub. No.: US 2006/0044935 A1
(43) Pub. Date: Mar. 2, 2006

(54) METHOD AND SYSTEM FOR PRODUCING A TEMPERATURE PROFILE IN A FOOD PREPARATION CONTAINER

(76) Inventors: Brandon P. Benelli, San Francisco, CA (US); Andrew L. Choy, San Francisco, CA (US); Philip G. Wessells, Mill Valley, CA (US); Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(21) Appl. No.: 11/161,975

(22) Filed: Aug. 24, 2005

Related U.S. Application Data
(60) Provisional application No. 60/604,205, filed on Aug. 25, 2004.

(51) Int. Cl. B01F 15/06

(52) U.S. Cl. 366/145; 366/206

(57) ABSTRACT

A temperature-controlled container includes a container having a temperature source incorporated into at least a portion of a sidewall of the container or into a retrofit influencer mounted proximate the container; and a power coupler, coupled to the temperature source, for receiving a power line coupled to a power source for operating the temperature source. In a preferred embodiment, the container is adapted to operate in conjunction with a power mixer. The method for processing one or more ingredients of a food recipe includes the steps of regulating a temperature source disposed in a wall of a container adapted for use with a mixing machine system, the container holding the one or more ingredients with the temperature source regulated to establish a desired temperature profile for the container appropriate for the recipe and/or the ingredients, the temperature source coupled to a power source through a power line coupled to an exterior port of the wall; and engaging the container with the mixing machine system; and thereafter operating the mixing machine system while the temperature source is being regulated.

### FIELD OF THE INVENTION

The present invention relates generally to cooking and food preparation equipment, and more specifically to a temperature conditioner, preferably retrofittable, for directly influencing a temperature of a container, and thereby indirectly influencing a temperature of food products within the container, used in cooperation with an electric mixing system for preparation of food recipes.

### BACKGROUND OF THE INVENTION

There are many types of cooking equipment used in commercial and consumer kitchens. Three common types of equipment are mixing machines, double boilers, and bowls, with the mixing machine often including a customized bowl for use in conjunction with the machine, and a double boiler for heating mixtures.

A mixer is a kitchen appliance intended for mixing, folding, beating, and whipping food ingredients. Mixers come in two major variations, hand mixers and stand mixers.

A hand mixer, as the name implies, is a hand-held device. It typically consists of a handle mounted over a large enclosure containing the motor, which drives two beaters. The beaters are immersed in the food to be mixed. Hand mixers may be battery-powered.

A stand mixer is essentially the same as a hand mixer, but is mounted on a stand which bears the weight of the device. Stand mixers are larger and have more powerful motors than their hand-held counterparts. They generally have a special bowl that is locked in place while the mixer is operating. Heavy duty commercial models can have bowl capacities in excess of 100 quarts (95 L), but more typical home and commercial models are equipped with bowls of around 4 quarts (4 L). A typical home stand mixer will include a wire whip for whipping creams and egg whites; a flat beater for mixing batters; and a dough hook for kneading.

Mixers should not be confused with blenders or food processors. Blenders and food processors contain sharp blades and typically operate at higher speeds that chop, liquefy, or otherwise break down larger food items. A mixer is a much slower device without blades.

FIG. 1 is an illustration of a side view of a conventional mixing system 100 including a motor 105, a stand 110, and a mixing bowl 115 detachably mounted to stand 110 in appropriate orientation to motor 105 so that any of several different beater styles (120) detachably mounted to motor 105 appropriately interacts with the contents of bowl 115 in any of several very well known ways. There are many mixing systems manufactured for home and commercial use, with Kitchenaid, Hobart, Univex, Globe, Hamilton Beach, Whirlpool, and the like. At least one of these manufacturers (i.e., Kitchenaid) makes mixing systems that are suitable for both home and commercial uses. Most Kitchenaid mixing systems include features for adding accessories for enhancing food processing abilities. For example, many Kitchenaid models include a power-take-off (PTO) 125 to which a grinder (grain or meat for example) or food mill may be attached and operated. Additionally, some Kitchenaid mixing systems include a pair of lateral pins 130 on a pair of lateral mounting arms 135 to which a cooling jacket may be attached (as shown in more detail in FIG. 2).

FIG. 2 is a front view of mixing system 100 shown in FIG. 1 including a cooling jacket 200 having a pair of clips 205 for repeatedly attaching/hanging jacket 200 from pins 130, usually while bowl 115 is coupled to mixing system 100 using a second pair of pins 210 on arms 135. Bowl 115 used with this system includes a pair of mating brackets 215 that permit detachable coupling of bowl 115 to pins 210 in the proper orientation for effective mixing with beater 120. In most cases, bowl 115 further includes a handle 220, the components of bowl 115 (including the bowl itself, brackets and handle are often constructed of stainless steel for durability and ease of cleaning). The arrangement of the mounting and coupling components is further illustrated in FIG. 3 as identified below.

In operation, jacket 200 is typically mounted to mixing system 115 after bowl 115 has been attached to arms 135. Jacket 200 is sized to provide a space S between an outer wall of bowl 115 and an inside wall of jacket 200. Space S completely surround a lower portion of bowl 115 and is used to retain ice and water so as to cool bowl 115 and any contents during operation of mixing system 100.

FIG. 3 is an exploded illustration of a coupling system 300 shown in FIG. 2 illustrating the arrangement and orientation of coupling and mating components for the mixing bowl and the water jacket described in connection with FIG. 2. Arm 135 both supports bowl 115 and jacket 200, but it also orients bowl 115 in the proper position relative to beater 120 and it orients jacket 200 in the proper position relative to bowl 115.

The depicted mixing systems are only representative of the types of conventional systems. In addition to the system shown in FIG. 1, there are larger commercial units having mixing bowls with multi-gallon capacity. Disadvantages associated with these commercial units are similar to some of those described herein, except typically the magnitude of the problem is greater. In some implementations, mixing bowl 115 is mounted via a bottom coupling to a base of mixing system 100. These implementations typically do not include arms 135.

A very common process used in the preparation of many types of food is heating or cooling ingredients of a food recipe. During the heating or cooling, the ingredients are often contained within a container and placed over an external temperature source. It is often necessary to circulate the ingredients during the heating or cooling for several reasons (as in emulsions), with some of the reasons dependent upon the recipe, the container materials, and temperature level. For example, with some containers having thin metallic walls and an intense temperature source, the wall of the container adjacent the temperature source can become too intense (as in sensitive egg mixtures) and adversely affect the desired outcome of the recipe. In other recipes, it is often necessary to combine or mix ingredients while maintaining a precise temperature of the ingredients, with different temperatures desired for different recipes under varying conditions (e.g., altitude and humidity in regards to chocolate tempering). It takes a great deal of skill to maintain a desired temperature level while adding and mixing ingredients, assuming that the desired or optimal temperature is known for the particular recipe. Particularly because the mixing and combining while heating and/or cooling need be performed over a cooktop necessitating monitoring the temperature and other factors while mixing and adding the ingredients at the proper time and in the proper way.

There are phases during many recipes where an operator is required to closely monitor the food contents/temperature or other recipe parameter, often at the exclusion of all other tasks that the operator could be undertaking during the period. This drawback is particularly acute in commercial environments in which many people concurrently prepare many recipes. Having one operator focus exclusively on a single aspect of a single recipe or preparation step negatively impacts a ratio of operators to recipes completed.

In the preparation and processing of food ingredients of a recipe, there are often important temperature levels for a particular class of food ingredient or processing technique. Table I below identifies some classes of food ingredients and a corresponding relevant temperature.

TABLE I

| Ingredient | Subprocess | Temperature | | |
|---|---|---|---|---|
| Class/Technique | Tech | ° F. | C. | |
| Frozen | | Near | Near | |
| dessert/Storage | | Freezing | Freezing | |
| (e.g., Ice Cream, | | | | |
| Italian Ice) | | | | |
| Hand-operated Ice | | Below 40 | Below 4.4 | C. |
| Stick | | | | |
| Bread Proofing | | 75-80 | 27 | C. |
| Yeast dissolving | | 75-90 | 30 | C. |
| Chocolate | | 115 | 48 | C. |
| tempering | | | | |
| Eggs | Whites | 145-150 | 63-66 | C. |
| | Yolks | 175-180 | 82 | C. |
| | Mixture (e.g., | 190 Max. | 88 | C. |
| | pastry cream) | | | |
| Boiling Liquid | E.g., Risotto | 212 | 100 | C. |
| Simple | | 212+ | 100 | C.+ |
| Syrup/Candy | | | | |
| | Thread | 223-234 | 106-112 | C. |
| | Soft Ball | 234-240 | 112-116 | C. |
| | Firm Ball | 242-248 | 116-120 | C. |
| | Hard Ball | 250-265 | 121-129 | C. |
| | Soft Crack | 270-290 | 132-148 | C. |
| | Hard Crack | 300-310 | 149-154 | C. |

*Temperature may vary according to pressure/humidity

In the food service industry, it is known to heat food ingredients in many different ways. For pans, pots, double boilers, or other containers used on a stovetop, a gas flame or heated electric element radiates heat to an exterior surface of the container. The container is heated, which in turn heats the contents of the container to the desired temperature level. It is also known to use induction to directly heat a container without using a heat source. Induction uses electromagnetic energy to heat cookware made of magnetic material (steel, iron, nickel or various alloys). When an induction unit is turned on, coils of the unit produce a high frequency alternating magnetic field, which ultimately flows through the cookware. Molecules in the cookware move back and forth rapidly, causing the cookware to become hot and cook the food.

It is also known to use a heating element in conjunction with a container of food preparation system, such as a food processor or blender. A heating element is disposed in a bottom or in the sidewall for heating the contents when powered through a connector in the base of the system. The container cannot be used independent of the system.

In these cases, it is desired to create a single uniform heat level for the heated area of the container, with temperature variations expressly avoided. The construction of the containers is designed to make the heating as uniform as is possible to economically achieve maximum efficiency.

Mixing system 100 has several disadvantages as a temperature control system for achieving the desired temperature level(s) shown in Table I. A chief disadvantage is that mixing systems do not employ heating components, and with the exception of the narrow, specific example of the ice jacket implementation, temperature control for food contents is not available for mixing systems of the type shown. Other disadvantages of the prior art is that mixing system 100 are unable to precisely set and maintain the desired temperature level over extended periods, particularly for high temperatures for a length of time necessary to entirely complete a desired recipe. The temperature of the contents of jacket 200 (e.g., ice or water) moves toward room temperature. While ice may be added, it may not be added indefinitely. Hot water usually cools fairly rapidly, making it unsuitable for maintaining any single temperature for any duration. Also, it is generally not simple or easy for an operator to produce a necessary quantity of water at precisely the correct temperature. Further, some temperature levels are not achievable using jacket 200 (e.g., the simple sugar temperature levels that exceed the boiling temperature of water). System 100 is limited to a temperature range of boiling to freezing. Additionally, the speed by which the contents of bowl 115 has its temperature effected is influenced by a temperature gradient between the contents of jacket 200 and the temperature of the contents, as well as the construction of bowl 115. Temperature transfer characteristics of the material of bowl 115 are not usually considered during the construction of the bowl. Still further, mixing system 100 such as shown in FIG. 1 are designed with an emphasis on mixing which will homogenize the contents of bowl 115 fairly quickly. Extended preparation of some recipes using a constantly running mixer, even at the lowest speed, will produce unsatisfactory results. For example in risotto preparation, the rice does not efficiently absorb the liquid as it would if it were mixing at a lower speed.

Electrically and thermally conductive resins (i.e., plastics) are commercially produced today in limited quantities. However, demand for thermally and electrically conductive resins is rapidly growing due to more stringent regulation on electronic noise, as well as the increased need for smaller, more densely packed electronic components.

Accordingly, what is needed is a system and method for providing a user with an ability to set and maintain a desired temperature for food processing as well as to assist a user in combining, mixing or processing ingredients of a recipe while maintaining the desired temperature at the appropriate level and permitting a user to work independently when desired, freeing the user to address other tasks at hand while the mixing operation continues automatically. The present invention addresses such a need.

### BRIEF SUMMARY OF THE INVENTION

A temperature-controlled mixing system includes a container having a temperature source incorporated into at least a portion of a sidewall of the container or into a retrofit influencer mounted proximate the container; and a power coupler, coupled to the temperature source, for receiving a power line coupled to a power source for operating the temperature source. In a preferred embodiment, the container is adapted to operate in conjunction with a power mixer having a single downward-pending beater. The method for processing one or more ingredients of a food recipe includes the steps of regulating a temperature source, disposed in a wall of a container adapted for use with a mixing machine system or as a retrofit proximate influencer, the container holding the one or more ingredients with the temperature source regulated to establish a desired temperature profile for the container appropriate for the recipe and/or the ingredients, the temperature source coupled to a power source through a power line coupled to an exterior port of the wall; and engaging the container with the mixing machine system; and thereafter operating the mixing machine system while the temperature source is being regulated. In another preferred embodiment, the duty cycles (on and off) of the mixer are also controlled by the power source to mix the food contents at an appropriate speed consistent with the recipe, food contents, and operational point of the recipe (e.g., near a beginning, a middle, or an end of the recipe or recipe phase). The temperature/duty cycle may be established according to a preset static schedule or dynamically responsive to conditions monitored by the system.

The system and method provides a user with an ability to set and maintain a desired temperature profile for food processing as well as to assist a user in combining, mixing or processing ingredients of a recipe while maintaining the desired temperature profile of a container and/or mixing speed. The preferred embodiment is adapted to be useful both as a stand-alone unit and when used in conjunction with a mixing machine. In addition, the container is able to maintain temperature and work independently while the user performs additional duties. The ability of embodiments of the invention to permit a single chef/food preparer to multiplex their attention among one or more additional tasks while also mixing/executing food recipes including various mixing tasks, especially mixing/agitating while heat is applied, is one advantage of the present invention. Other advantages include maximizing product, improving consistency, and increasing versatility in a range of recipes (see Table I) that may be produced by an appliance.

### BRIEF DESCRIPTION OF THE DRAWINGS

FIG. 1 is an illustration of a side view of a conventional mixing system including a motor, a stand, and a mixing bowl detachably mounted to the stand in appropriate orientation to the motor so that any of several different beater styles detachably mounted to the motor appropriately interacts with the contents of the bowl in any of several very well known ways;

FIG. 2 is a front view of the mixing system shown in FIG. 1 including a cooling jacket having a pair of clips for repeatedly attaching/hanging jacket from pins, usually while the mixing bowl is coupled to the mixing system using a second pair of pins on the arms;

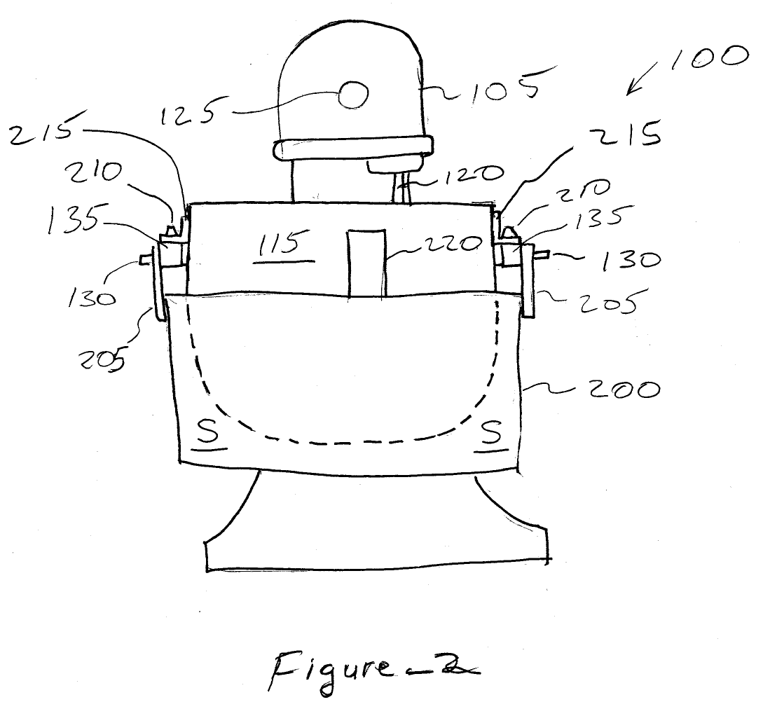

FIG. 3 is an exploded illustration of a coupling system shown in FIG. 2 illustrating the arrangement and orientation of coupling and mating components for the mixing bowl and the water jacket described in connection with FIG. 2;

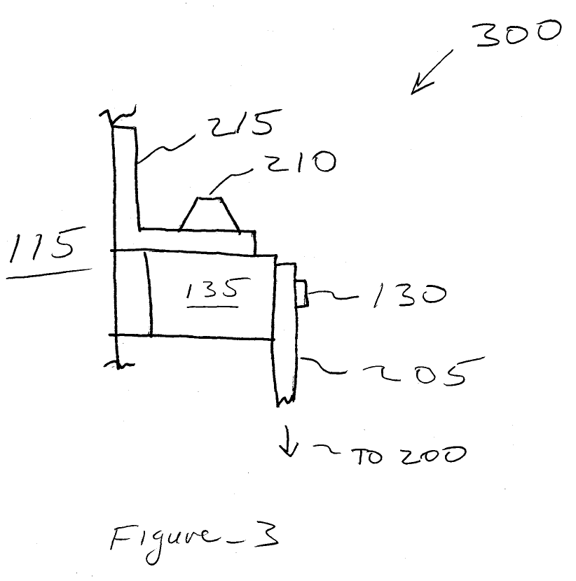

FIG. 4 is a front perspective view of a temperature-controlled mixing system including a mixing system (e.g., the mixing system shown in FIG. 1) additionally including a detachable retrofit temperature influencer;

FIG. 5 is a front perspective view of a preferred embodiment for the temperature-controlled mixing system shown in FIG. 4 illustrating a powered temperature influencer and associated controller;

FIG. 6 is an exploded illustration of a coupling system shown in FIG. 5 illustrating the arrangement and orientation of coupling and mating components for the mixing bowl and the temperature influencer described in connection with FIG. 5;

FIG. 7 is a front view of the controller shown in FIG. 5;

FIG. 8 is a top view of the temperature influencer shown in FIG. 4 and FIG. 5;

FIG. 9 is a bottom view of the temperature influencer shown in FIG. 4 and FIG. 5; and

FIG. 10 is a perspective view of a preferred embodiment for an ice stick beater attachment.

### DETAILED DESCRIPTION OF THE INVENTION

The present invention relates to providing a user with an ability to set and maintain a desired temperature for food processing as well as to assist a user in combining, mixing or processing ingredients of a recipe while maintaining the desired temperature. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

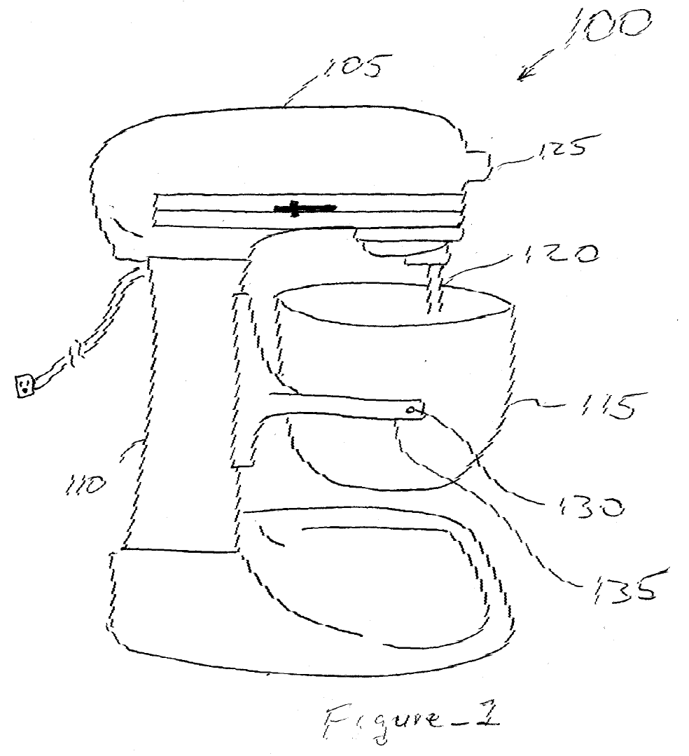

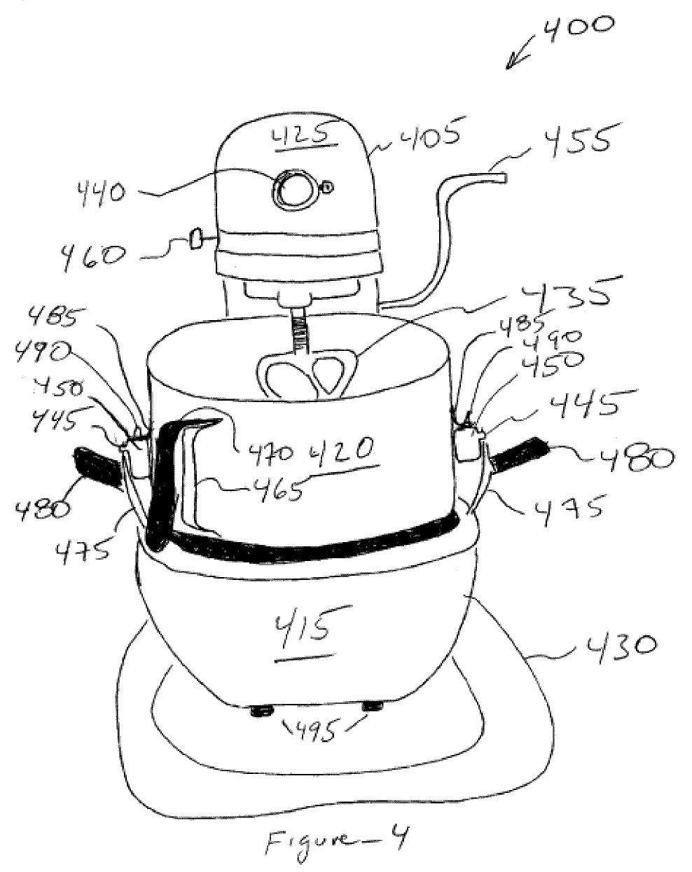

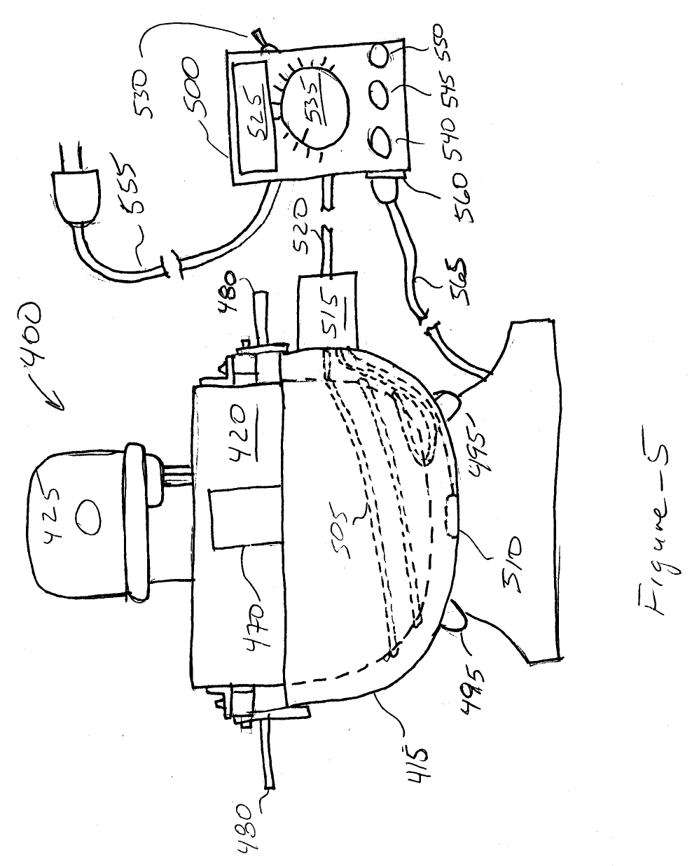

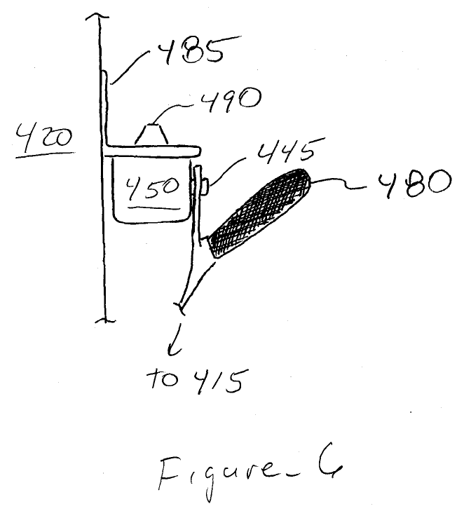

FIG. 4 is a front perspective view of a temperature-controlled mixing system 400 including a mixer 405 (e.g., mixing system 100 shown in FIG. 1) having a mixing bowl 420 and additionally including a retrofit temperature influencer 415. Mixer 405 includes a motor 425, a stand 430, and mixing bowl 420 detachably mountable to stand 430 in appropriate orientation to motor 425 so that any of several different beater styles (435) detachably mounted to motor 425 appropriately interacts with the contents of bowl 420 in any of several very well known ways. There are many mixing systems manufactured for home and commercial use, with Kitchenaid, Hobart, Univex, Globe, Hamilton Beach, Whirlpool, and the like. At least one of these manufacturers (i.e., Kitchenaid) makes mixing systems that are suitable for both home and commercial uses. Most Kitchenaid mixing systems include features for adding accessories for enhancing food processing abilities. For example, many Kitchenaid models include a power-take-off (PTO) 440 to which a grinder (grain or meat for example (not shown)) or food mill (not shown) may be attached and operated. Additionally, some Kitchenaid mixing systems include a pair of lateral pins 445 on a pair of lateral mounting arms 450 to which temperature influencer 415 may be attached (as shown in more detail in FIG. 5 and FIG. 6). Mixer 405 includes a crank 455 used to raise and lower arms 450 (and thereby raise/lower mixing bowl 420 relative to motor 425/beater 435 for the proper orientation for mixing/removal). Motor 425 typically includes a control 460 for setting a mixing speed. Mixing bowl 420 includes both a conventional handle 465 as well as a temperature insulated/resistive handle 470. Influencer 415 is positioned in operational mode relative to mixing system 400 by use of a pair of clips 475 that attach to lateral pins 445. Each clip 475 includes an insulated handle 480 for use in attaching/detaching influencer 415. Similarly to mixing system 100, in some embodiments mixing bowl 420 includes a pair of mounting brackets 485 for mounting to a pair of vertical mounting pins 490 positioned on arms 450. Further, influencer includes a trio of temperature insulative/resistive feet 495 (one not shown).

FIG. 5 is a front perspective view of a preferred embodiment for the temperature-controlled mixing system 400 shown in FIG. 4 illustrating a powered temperature influencer 415 and an associated controller 500. Temperature influencer 415 is preferably a bowl-like structure adapted as described below for use with mixer 405 (e.g., machine systems from KitchenAid® or Hobart®) and including feet 495 for use as an independent stand-alone temperature influencer (in which a suitable bowl rests within an operational cavity). As further described below, influencer 415 includes one or more temperature sources 505 for establishing a desired temperature profile. Temperature sources 505 may be adapted for heating, for cooling, or in some instances, both heating and cooling. Additionally, the preferred embodiment includes a sensor 510 (e.g., a temperature sensor) for measuring one or more operational parameters and communicating appropriate parameter signals (e.g., temperature or a voltage/current scaled responsive to a temperature) to controller 500.

Active temperature sources 505 and sensor(s) 510 of the preferred embodiment are communicated to controller 500 through a coupler 515 disposed on an outer portion of a sidewall of influencer 415 and a power/data line 520. Additionally, coupler 515 permits access to other temperature sensors or other features or process parameters as described below when disposed within influencer 415.

In one preferred embodiment, the temperature sources are electrical resistive heating elements (as shown) and coupler 515 is a system for powering the elements using conventional power processed by controller 500. Alternatively to that shown, in some embodiments controller 500 may be incorporated into influencer 415 and this powering system may have a power line permanently affixed directly influencer 415. In other arrangements, controller 500 may be incorporated into mixer 405 and powered by line power available through the mixer's power system.

In some cases, temperature sources 505 may use a fluid or gas circulating inside channels incorporated into the sidewall, or burning gases in some instances. Coupler 515 in such a case may provide a coupling system for using an external compressor/supply line to condition the fluid or gas for use with container influencer 415.

In other cases, temperature sources 505 are a preselected composition of materials having different expressed thermal properties in cooperation with the operating environment (e.g., variable magnetic inductive heating of different regions having different magnetic densities with the different regions achieving different temperatures when presented with a similar electromagnetic impulse or signal). It is possible to use multiple temperature sources 505 as well as different types of temperature sources 505 in a single influencer 415.

The preferred embodiment of influencer 515 creates a desired temperature in specific regions of mixing bowl 420 during operation of one or more temperature sources. The preferred embodiment predictability, controllably and accurately recreates the desired temperature for a user without the user needing to research a proper temperature profile or monitor temperature sources 505 to produce the desired temperature.

In the preferred embodiment, the bowl temperature also includes a time component. Temperature levels may have a desired duration and/or cycling period between two or more levels. In some applications, a temperature sensor and timer are used to set and maintain the desired temperature over the appropriate period and temperature range(s).

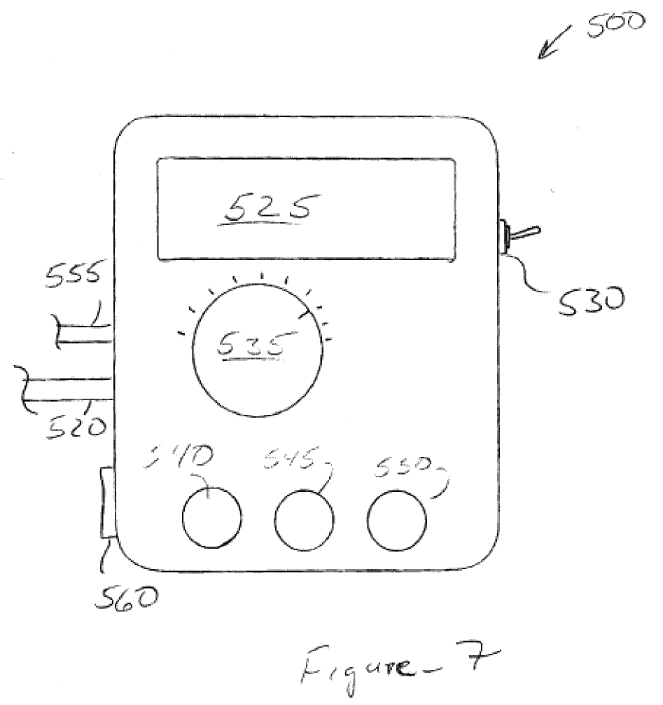

Controller 500 includes a display 525, an on/off switch 530, a temperature dial 535, a temperature intensity control 540, and duty cycle controls (“on” duration control 545 and “off” duration control 550). Additionally, controller 500 includes a power line 555 for receiving line power and at least one power outlet 560 for receiving a line power cord 565 for mixer 405. FIG. 7 is a front view of a preferred controller 500 shown in FIG. 5 for use with the present invention.

Display 525 provides status and informational signals/data to a user, such as operating temperature of influencer 415. Temperature dial 535 permits a user to set a desired temperature for temperature sources 505 in actual temperature setting or functional (e.g., setting specifies a function in first/second column of Table I above with controller converting to the necessary temperature). Intensity control 540 determines how quickly temperature sources 505 reach the desired temperature. The duty cycle controllers 545 and 550 set a duty cycle for the power provided to outlet 560. In the preferred embodiment, when power cord 565 of mixer 405 is powered through outlet 560, duty cycle controllers set the on and off delay of the mixer motor speed, the maximum speed of which is typically set by control 460 shown in FIG. 4. In some implementations, it is possible to alter a speed of the mixing speed by controlling a voltage level (for external controllers) while for controllers 500 incorporated into a mixer, the speed control may be directly established according to a desired operating profile and responsive in some cases to various process parameters.

Controller 500 includes temperature control 535 and temperature feedback indication 525 for use in setting the desired temperature. In some alternative embodiments, control 535 includes a manual temperature level slider for manually setting the temperature level of the temperature source(s) to a desired level. This slider may include one or more detents at various locations corresponding to presets representing the classifications in Table I.

A temperature control 535 also includes an array of buttons, each button of this array associated with a particular temperature classification/setting. Each particular temperature classification/setting configures temperature source(s) 505 of influencer 415 to a preselected level, duration and cycling to establish the selected processing profile for influencer 415. In some implementations, the array not only sets (or alternatively sets) a temperature/temperature cycle, but is also configures the duty cycles of the mixer.

Temperature indication 525 of the preferred embodiment is a digital temperature display for indicating the actual temperature of temperature source(s) 505. Temperature indication 525 works cooperatively with one or more temperature sensors (e.g., sensor 510) inside influencer 415 or through other sensors (not shown) exposed to influencer 415 or to the contents of mixing bowl 420 (such as IR sensors or color/humidity or other process-specific sensors.

In some applications, controller 500 may provide an indication of each temperature source 505, or an indication of the temperature of influencer 415 or mixing bowl 420 at a particular location. In some instances, controller 500 may not provide any manual controls for temperature, or timing producing an automated controller. In other instances controller 500 will have only manual controls, perhaps with one or more detents. Some controllers 500 will not include temperature indication 525. As discussed above, influencer 415 may include multiple numbers of multiple types of temperature sources 505. Controller 500 may become complex as the number and types of temperature sources increases, and as the complexity of process profile control increases through timing and other factors. For example, in some instances it may be desirable to automatically adjust a preset temperature profile based upon altitude (pressure) or humidity or other environmental conditions including ambient temperature, for which sensors of each type could also be included appropriately in system 400 and monitored by controller 500.

FIG. 6 is an exploded illustration of a coupling system 600 shown in FIG. 4 and FIG. 5 illustrating the arrangement and orientation of coupling and mating components for the mixing bowl and the temperature influencer described in connection with FIG. 4 and FIG. 5. Arm 450 both supports bowl 420 and influencer 415, but it also orients bowl 420 in the proper position relative to beater 435 and it orients influencer 415 in the proper position relative to bowl 420.

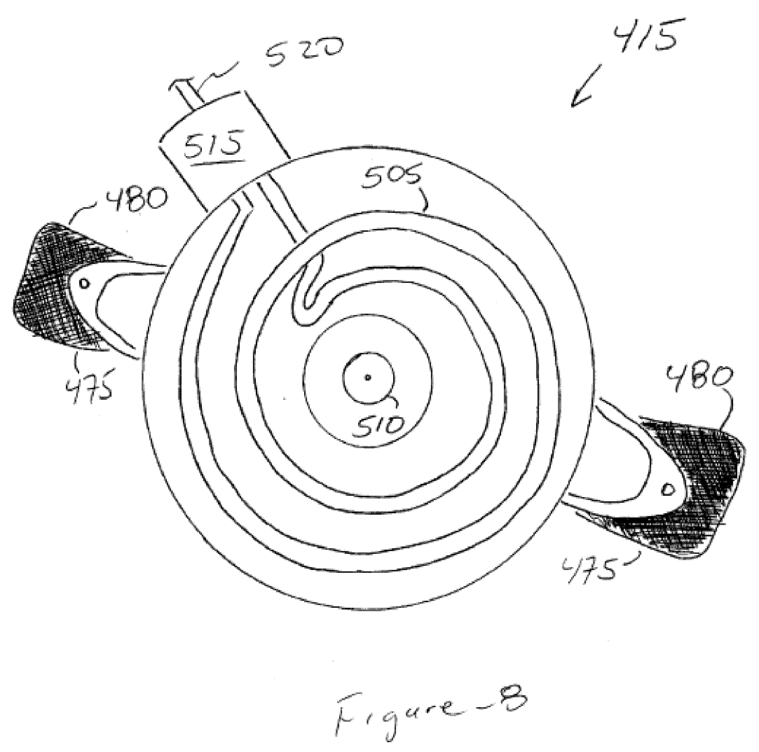

FIG. 8 is a top view of temperature influencer 415 shown in FIG. 4 and FIG. 5. In FIG. 8, a preferred embodiment for temperature sources 505 is shown as a spirally wound heating coil within a cavity of influencer 415 sized to receive mixing bowl 420. Clips 475 are rotatable to selectively engage with and disengage from lateral pins 445 using insulated grips 480.

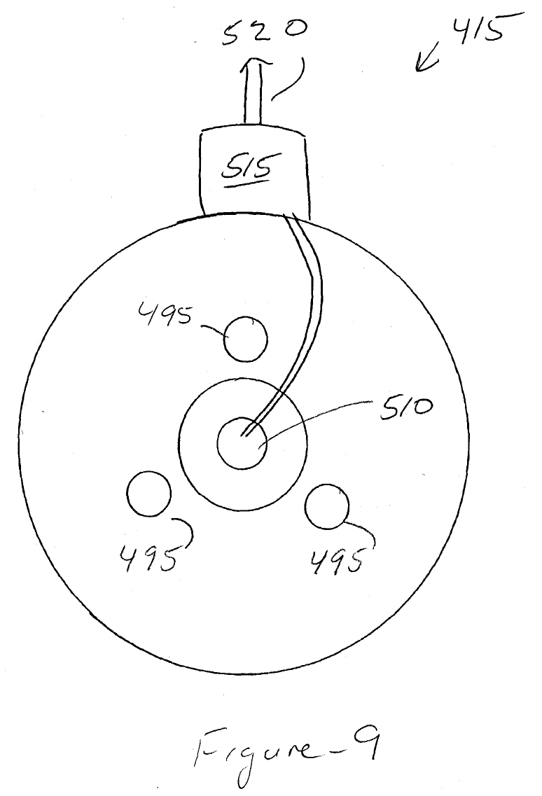

FIG. 9 is a bottom view of temperature influencer 415 shown in FIG. 4 and FIG. 5. Shown are the trio of insulated fit 495 permitting influencer 415 to operate in an independent stand-alone mode (heating contents of a bowl without access to a mixing function of system 400.

As shown, influencer 415 may be configured to operate temperature sources 505 at high enough temperatures that a user may be potentially discomfited or injured. When configured for temperatures that may cause discomfort or injure an operator, exterior portions and grips of influencer 415 and bowl 420 may include insulation on exterior layers or portions of such layers.

Temperature sources 505 in the preferred embodiment are heating elements that respond to a predetermined flow of electric current to produce a particular temperature and a particular watt density that may vary over time, as established by controller 500. That temperature profile/watt density is communicated to the recipe contents within mixing bowl 420 provided the cavity of influencer 415.

In operation, influencer 415 mounts under mixing bowl 420 via clips 475 attaching to lateral pins 445. This mounting configuration provides that mixing bowl 420 is at least partially received within the cavity of influencer 415 and operationally proximated to temperature sources 505. The predetermined flow of electric current, as determined by controller 500 on a static or dynamic schedule, is communicated to sources 505 to establish the desired temperature pattern and watt density for the contents of the mixing bowl.

Modifications to influencer 415 may be necessary for use with mixing systems that include a bowl mount on an underside of the bowl (as opposed to the use of brackets 485 to suspend the bowl using vertical pins 490 on arms 445), such modifications contemplated to be within the spirit and scope of the present invention. Additionally, influencer 415 may be incorporated into a mixing bowl and still be within the scope and spirit of the present invention.

Controller 500 may include additional/alternate features and controls different from those disclosed above, such as an operator intervention/monitoring indicator.

As noted above, in a preferred embodiment, an operator may plug a line power plug of the electric motor into controller 500 rather than into a conventional line supply outlet. The mixer operation timer may control a duty cycle of the electric motor to control an operational speed as well as an operational duty cycle for an on time and an off time. The mixer operation timer may be statically determined by controller 500 or fully automatic and dynamic to set both a temperature pattern but also a mixing profile. For example, mixer operation timer may establish that the mixer motor runs for a ten second period once every two minutes. The maximum top speed is established by the speed setting of the motor, however the mixer operation timer may, for some electric motors, also determine a speed (as a fraction of the maximum speed) of mixer operation. An operator may also statically determine that speed over the course of a recipe preparation, or controller 500 may dynamically set/change the speed during operation as the processing continues in response to a lapse of time or other measurable process parameter.

Controller 500 may include, in addition to or in lieu of, the temperature pattern setting of a desired temperature level, but also may include a setting for an “intensity setting” for how quickly the desired temperature level is achieved. There are many ways to achieve this dependent upon the construction and operation of the temperature sources 505. This feature provides an ability to gently raise a temperature for recipes and delicate food products that may be damaged by too quick of a temperature rise. In some cases, the food contents or the recipe may not be adversely affected by a quick temperature change, then a maximum temperature rise permits a greater time savings to be realized.

The operator intervention/monitoring indicator is a display, light, sound, or other perceptible stimulus provided to an operator that the recipe/food contents need, or may need, attention. Depending upon the particular embodiment and specified use, controller 500 may provide the operator with different indications, some of which may be dependent upon the particular recipe. In some cases, the indicator may be a preestablished or operator determined elapsed time. In other cases, it may be when a measurable or perceptible attribute of the food contents or of the food preparation apparatus achieve, exceed, meet or fall below some threshold. This can be a temperature, moisture level, viscosity, color, or other feature that is detected and acted upon to alert an operator.

It is known that growth of contaminant food bacteria is reduced by storing recipe/food ingredients in a safety zone (i.e., either at a temperature greater than 140 degrees Fahrenheit or at a temperature below 40 degrees Fahrenheit). System 400 illustrated in FIG. 4 describes a single food preparation system that is used to make, store, and reheat a recipe. For example a hot soup may be made in container 400 using a high temperature profile. The soup is then cooled for storage pending a serving time. Container 400 may then be used to reheat the soup to the desired serving temperature.

It is common for operators to make large quantities of various stocks, soups, and other liquid components. It is also common for operators to manually cool these liquid products until they reach the safety zone. One purpose of rapid cooling is to dramatically improve a shelf life of the food item because a risk of food bacteria has been reduced. An important aspect of the present invention in relieving chefs/food preparers from manual tasks. It is another preferred embodiment of the present invention to provide for a beater ice stick that may be used to rapidly decrease a temperature of a food item into the safety zone.

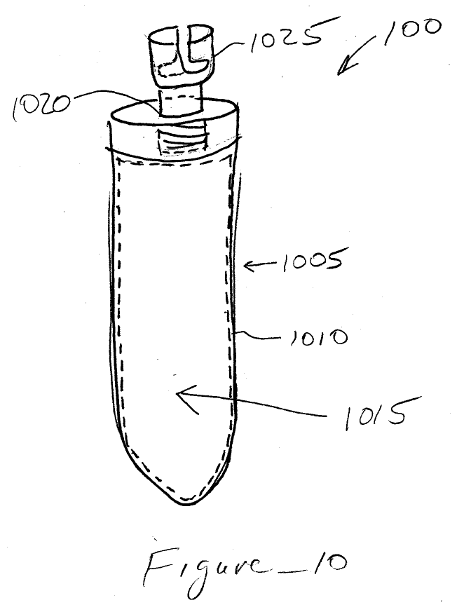

FIG. 10 is a front perspective view of a preferred embodiment for one such beater ice stick 1000. Stick 1000 includes a body 1005 having an exterior wall 1010 defining a cavity 1015. Cavity 1015 is accessed via a top port 1020 (e.g., a threaded port) preferably pluggable using a coupler 1025 adapted to engage a beater shaft of a motor of a mixing system (e.g., system 400 shown in FIG. 4). In this configuration, stick 1000 is attachable to the motor like any other beater 435 to interact with bowl 420 contents.

In the preferred embodiment, cavity 1015 is filled with a compound that imparts a temperature below 40 degrees Fahrenheit so that the bowl contents are cooled automatically by operation of stick 1000 in cooperation with the mixing system. Water, non-toxic antifreeze or other liquid/solid compound that resists heating may be added through port 1020 (or presealed in the case of some compounds). The filled stick 1000 is cooled and then may be used to cool bowl 420 contents. This simple expedient permits an operator to attend to other tasks as the food contents are stirred/cooled automatically.

Additional features of mixing system 400 include a mixing bowl 420 that may be constructed for in-bowl recipe production rather than simple mixing. For example, bowl 420 may be provided with a non-stick interior or other features adopted from stovetop ware for aiding the even heat transfer, efficient cooking, and quick clean-up after recipe completion. Further, special paddles/beaters 435 are provided for stirring/folding/processing bowl contents for sustained mixing/stirring during temperature alternation rather than simply mixing the contents of a mixing bowl. Some implementations of the preferred embodiment may serve as an automated, utilitarian “wok” “hot plate” or “double boiler” substitute. For example, in the stand alone mode, influencer 415 may be used as a dough/bread proofer to maintain bowl contents, post mixing, at the proper temperature to enhance product quantity.

It is contemplated to be within the scope of the present invention that the influencer and controller, shown to be retrofit elements, could be directly incorporated into the mixing/cooking bowl and motor control. Controller 500 may have use outside the preferred embodiment as an appliance controller for other types of devices, particularly the speed/duty cycle controller for appliances. Additionally, in some modern appliances, controllers include computer program products for implementing some features and characteristics.

The preferred embodiment of the present invention provide both a home chef of any cooking level as well as a professional culinary practitioner with a tool for improving the preparation of a wide range of recipes. For example, mixing system 400 provides a professional chef with a way to prepare many time intensive recipes that require constant stirring/supervision with more efficiency. For a commercial setting, the ratio of operators/recipes completed is improved. A better, more consistent product is produced and in many cases, the automation decreases the overall preparation time and maximizes the volume of the product (e.g., whipping). Cooking facilities will be able to produce a wider range of recipes and will not have to avoid certain operator-intensive recipes (e.g., risotto) because of a limited operator availability. Another example is maximizing a volume of a whipped sauce (e.g., Hollandaise) to fill more orders from a single recipe. The home chef will also be able to make better products in that certain recipe parameters will be better controlled and more even (e.g., stirring or temperature levels) permitting the home chef to focus on the more enjoyable aspects of recipe production and/or entertaining.

Other embodiments of the present invention include a new cooking center that mixes and adds ingredients automatically related microprocessor controlled mixing/heating profiles i.e., speed, duration, temperature, temperature ramping. These systems may include thermo-sensing mixing attachments for accurate temperature control and automatic speed control based on motor current draw or strain transducer in mixing attachment (to adjust mixing/heating to content viscosity and compared to a preestablished model/recipe).

Although embodiments of the invention have been described primarily with respect to discrete control elements, other implementations may similarly benefit from features of the invention.

One of the preferred implementations of the present invention is as a routine in an operating system made up of programming steps or instructions resident in a memory of a computing system embodied in an electric/electronic mixer (or controller thereof) during computer operations. Until required by the computer system, the program instructions may be stored in another readable medium, e.g. in a disk drive, or in a removable memory, such as a memory/program module, an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet including satellite communications and propagated signals, when required by the user of the present invention. One skilled in the art should appreciate that the processes controlling the present invention are capable of being distributed in the form of computer readable media or propagated signal using a transmission medium in a variety of forms. For example, network communications may enable remote operation from remote locations (e.g., turn on time, turn off time, and other controller parameters).

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed as new and desired to be protected by Letters Patent of the United States is:

1. A food preparation mixing system, comprising:
a food-preparation mixer motor supported by a stand, said mixer motor driving one or more mixing implements;
a bowl, coupled to said stand, for containing said one or more mixing implements during a mixing operation;
a temperature influencer, coupled to said bowl, for influencing a temperature of a content of said bowl during said mixing operation;
an electronic temperature controller, coupled to said temperature influencer, for setting said temperature.

2. The mixing system of claim 1 wherein said temperature controller sets a temperature gradient for said temperature to control a period for transitioning said bowl from a current temperature to a desired value for said temperature.

3. The mixing system of claim 1 wherein said temperature controller includes a heating influencer.

4. The mixing system of claim 1 wherein said temperature controller includes a cooling influencer.

5. The mixing system of claim 1 wherein said temperature influencer is integrated into said bowl.

6. The mixing system of claim 1 wherein said temperature influencer includes a retrofit influencer for communicating a temperature source to said bowl.

7. The mixing system of claim 1 further comprising a mixing operation controller coupled to said mixer motor for setting a duty cycle for said mixing operation.

8. The mixing system of claim 7 wherein said mixing operation controller is included in an external housing and controls said duty cycle by controlling a power source for said mixer motor.

9. The mixing system of claim 8 wherein said mixer motor includes a power cord for accessing said power source and wherein said power cord is communicated to said power source through said mixing operation controller.

10. The mixing system of claim 7 wherein said mixing operation controller includes one or more preset static duty cycles.

11. The mixing system of claim 7 wherein said mixing operation controller provides for dynamically varying said duty cycle.

12. The mixing system of claim 1 further comprising a sensor for detecting a mixing operation parameter.

13. The mixing system of claim 12 wherein said parameter is a condition of the contents of said bowl during said mixing operation.

14. The mixing system of claim 12 further comprising an indicating system responsive to said mixing operation parameter to indicate a value for said mixing operation parameter during said mixing operation.

15. The mixing system of claim 1 wherein said bowl is coated with a wear-resistant non-stick coating.

16. The mixing system of claim 1 wherein at least one of said one or more mixing implements is adapted for contacting a bottom of said bowl and stirring a portion of said content during at least a portion of said mixing operation.

17. The mixing system of claim 1 wherein at least one of said one or more mixing implements includes a temperature-storage capacity for changing said temperature of said content during an extended mixing operation.

18. A mixing method, the method comprising:
a) influencing a temperature of a content of a bowl of a food preparation mixing apparatus during a mixing apparatus, said bowl coupled to a stand supporting a food preparation mixer motor driving one or more mixing implements and said bowl containing said one or more mixing implements during said mixing operation; and
b) setting said temperature using an electronic controller.

19. The mixing method of claim 18 further comprising:
c) setting a duty cycle of said mixer motor using said electronic controller coupled to an external power supply cord of said mixer motor.

20. In a meal preparation system having a chef personally invest a first quantity of time in a stirring-while-cooking process and a second quantity of time in a plurality of non-stirring-while-cooking processes said first quantity and the second quantity defining a total preparation time, a method of increasing the plurality of non-stirring-while-cooking processes, the method comprising:
a) automating the stirring-by-cooking process using a temperature-influencing mixing system having an influencer for influencing a temperature of a content of a bowl of said mixing system to a desired food-preparation temperature during a mixing operation of said mixing system while controlling a duty cycle of said mixing operation; and
b) monitoring said automated stirring-by-cooking process using a third quantity of time less than the first quantity of time; and
c) increasing the second quantity of time by about the first quantity minus the third quantity wherein the total preparation time is substantially unchanged.
